(19) United States
(12) Patent Application Publication
(10) Pub. No.: US 2019/0286304 A1
(43) Pub. Date: Sep. 19, 2019

(54) System and Method for Controlling the Graphic User Interface Elements

(71) Applicant: OOO ITV Group, Moscow (RU)

(72) Inventors: Murat K. Altuev, Chernogolovka (RU); Ivan Y. Kalugin, Balashikha (RU)

(21) Appl. No.: 16/167,538

(22) Filed: Oct. 23, 2018

(30) Foreign Application Priority Data
Mar. 16, 2018 (RU) 2018109390

(51) Int. Cl. G06F 3/0484; G06F 3/0481; G06F 3/0482; H04N 7/18

(52) U.S. Cl. CPC G06F 3/04845; H04N 7/181; G06F 3/0482; G06F 3/04815

(57) ABSTRACT

The present group of inventions relates to the sector of the graphical user interfaces, and more specifically to systems and methods for controlling the elements of the graphical user interface for displaying the information received from the video surveillance cameras. The computer system for controlling the graphical user interface elements contains the data processing device; a memory unit configured for storage of the data; data input/output device; and the graphical user interface (GUI). The computer system is executed with the possibility of providing the user with the opportunity to select at least one unit of control elements for transferring the unit to the control mode, visualization of the graphical representation of the 3D shape in the three-dimensional space of GUI under the control mode, and controlling rotation along the axes of coordinates of the 3D shape in the three-dimensional space of GUI. The technical result of the claimed group of inventions is a broader range of technical means regarding controlling the elements of the graphical user interface.

### RELATED APPLICATIONS

This application claims priority to Russian Patent Application No. RU 2018109390, filed Mar. 16, 2018, which is incorporated herein by reference in its entirety.

### FIELD OF THE INVENTION

The present invention relates to the sector of the graphical user interfaces, and more specifically to systems and methods for controlling the elements of the graphical user interface for displaying the information received from the video surveillance cameras.

### BACKGROUND

In the general case, Graphical User Interface (GUI) represents a system of means for user interaction with the computer system based on representation of all system objects and functions available to the user in a form of graphic components of the screen (windows, icons, menus, buttons, lists, etc.). At the same time, the user has random access (by means of input devices) to all visible display objects—interface units, which are represented on the display.

Video surveillance systems are software and hardware or technical means that use, among other things, computer vision methods for automated data collection, based on the analysis of streaming video. Currently video surveillance systems like, for example, closed-circuit television systems (CCTV) are rapidly deployed to ensure overall security in protected areas. These systems are equipped with a large number of video surveillance cameras.

The extent of how easily the users can interact with the software to control the process of video surveillance exerts a huge influence on the efficiency of using the security and protection systems. The simplicity of use and easiness of control are of primary importance especially when speaking about the routine operations (starting from the obligatory training of new operators and up to the direct response to the emergency situations).

The graphical user interface of the video surveillance system allows the following: displaying video from different video surveillance cameras on the monitor, representing the table of recorded violations, visual detection of the place of violation on the map of the area, playing back the video fragment related to any of the recorded violations (incidents), exporting video, performing search in the video archive and so on.

However, a huge growth of the volumes of information to be represented forces the developers to improve the graphical user interfaces. For example, in the video surveillance systems it is necessary to define/realize from what exactly camera the information must be obtained in order to display the video information. Currently, such playback settings are stored in a separate window and/or tab. At that, the context of the setting is lost that is the operator has to spend much time for searching for the settings for the required portion of the GUI functionality. Therefore, nowadays a problem to be solved is to develop the intuitively understandable interface providing for a fast and clear access to any of its components.

Development of three-dimensional (3D) user interfaces providing for a desktop workspace of greater effective area than that obtained during the two-dimensional displaying, is one of the ideas used for solving the above-mentioned problem. One of the most well-known from the field of invention solutions is represented by the US patent application No. US 2008/0013860 A1, published Jan. 18, 2008, along with that the method of creation of three-dimensional user interface is disclosed. This invention describes basic principles and means for implementation of the interactive three-dimensional user interface of any form. Nevertheless, different opportunities provided by such 3D interfaces are important for each sphere of engineering.

Also, another invention is known from the US patent application US 2003/0142136 A1, published Jul. 31, 2003, along with that the user interface system for simultaneously displaying a plurality of windows is disclosed. The above invention characterizes mapping of the data on the cube faces. At the same time, it is envisaged the opportunity of rotating this cube within the three-dimensional space in response to the user inputs. Each face of the cube has a window texture mapped thereon. Therefore, in accordance with the respective orientation of the cube the user can display several windows simultaneously. Main disadvantage of this system is in absence of automatic positioning of the content information related to main represented object on the remaining faces of the cube.

The closest in technical essence is the invention disclosed in the patent U.S. Pat. No. 8,537,157 B2, of Sep. 17, 2013, which characterizes the three-dimensional shape user interface for media content delivery systems and methods. The system includes the computing device and the data representing the 3D model of the shape including plurality of shape faces. Under the given invention the user chooses the media content, which will be displayed on one of the shape faces; and later on visualization of graphical representation of the three-dimensional shape is performed. Other shape faces contain either other TV programs or additional information. The 3D shape is executed with the possibility of rotation within the three-dimensional space. The main difference of this invention from the claimed invention is that it is aimed at providing media content properly. The main drawback of this invention is in absence of scaling at rotation that impedes complete and correct representation of the data. In addition, this invention does not imply the logic of visualization of the 3D shape graphical representation in the control mode only, i.e. directly for the purpose of image control.

### BRIEF SUMMARY

The invention is aimed at eliminating the drawbacks of the older-level equipment and developing the already known inventions.

The technical result of the claimed group of inventions is a broader range of technical means regarding the control over the graphical user interface elements.

This technical result is achieved due to the fact that the computer system for controlling the graphical user interface elements contains: at least one data processing device; a memory unit configured for storage of the data; data input/output device; the graphical user interface (GUI) executed with the possibility of representing the two-dimensional (2D) and three-dimensional (3D) elements depending upon the mode of operation, at that, in the basic operation mode GUI consists of several embedded 2D units of control elements; at the same time, the computer system is executed with the possibility of the following: providing the user with the opportunity to select at least one unit of control elements for transferring the unit to the control mode; visualization of the graphical representation of at least one 3D shape in the three-dimensional space of GUI under the control mode, at that, the selected unit of control elements is displayed in the two-dimensional representation on the front face of the 3D shape, and the context information related to the selected unit of control elements is automatically represented on the remaining all or several faces of the 3D shape; controlling rotation along the axes of coordinates of at least one 3D shape in the three-dimensional space of GUI according to the user's inputs arriving from the data input/output device, at that, during rotation of at least one 3D shape it is performed its automatic scaling so that all the context information positioned on one or all the faces of the 3D shape could be contained therein during the displaying.

In one possible implementation of the invention, the unit of control elements is represented by the video data received from the camera of the closed-circuit television system (CCTV).

In another possible implementation of the invention, the unit of control elements is represented by several video streams received from the group of cameras of the closed-circuit television system.

In one possible implementation of the invention, the unit of control elements is represented by the map or plan of the area.

In another possible implementation of the invention, the unit of control elements is represented by the dashboard.

In one possible implementation of the invention, the unit of control elements is represented by the entire GUI.

In another possible implementation of the invention, the context information is represented by at least one of the following: the settings, dashboards or additional information.

In one possible implementation of the invention, the automatic placing of the context information on the remaining faces of at least one 3D shape is executed in compliance with the degree of relevance of the context information.

In another possible implementation of the invention control over rotation along the axes of coordinates is executed with the possibility of adjusting the direction and rate of the 3D shape rotation.

In one possible implementation of the invention, the system is additionally configured for automatic advancing of the 3D shape to its nearest face in the given direction at incomplete rotation of the 3D shape.

In another possible implementation of the invention, at automatic scaling of the 3D shape it is equally increased the scale of both the 3D shape and the entire GUI in general.

In one possible implementation of the invention, at automatic scaling of the 3D shape the scale of the 3D shape is increased in a way that the increased 3D shape superimposes on the remaining elements of the GUI thus obscuring them completely.

In another possible implementation of the invention, the user input device can be represented by a mouse, a keyboard, a joystick, a touchpad and a sensor keyboard.

In one possible implementation of the invention, the visualized 3D shape can be represented by any shape consisting of plane faces.

In another possible implementation of the invention, the visualized 3D shape can be represented by at least one of the following shapes—a cube, a cylinder with plane faces and a dodecahedron.

The specified technical result is also achieved due to execution of the method of controlling the graphical user interface elements, which is performed by the computer system containing the graphical user interface (GUI) executed with the possibility of representing the two-dimensional (2D) and three-dimensional (3D) elements depending upon the mode of operation, at that, in the basic operation mode GUI consists of several embedded 2D units of control elements, at the same time, the method includes the following: the stage of providing the user with the opportunity to select at least one unit of control elements for transferring the unit to the control mode; the stage of visualization of the graphical representation of at least one 3D shape in the three-dimensional space of GUI under the control mode, at that, the selected unit of control elements is displayed in the two-dimensional representation on the front face of the 3D shape, and the context information related to the selected unit of control elements is automatically represented on the remaining all or several faces of the 3D shape; the stage of controlling rotation along the axes of coordinates of at least one 3D shape in the three-dimensional space of GUI according to the user's inputs arriving from the data input/output device, at that, during rotation of at least one 3D shape it is performed its automatic scaling so that all the context information positioned on one or all the faces of the 3D shape could be contained therein during the displaying.

And also, this technical result is achieved due to a computer-readable data carrier comprising instructions executable by the computer processor for implementing variants of methods for controlling the graphical user interface elements.

### BRIEF DESCRIPTION OF THE SEVERAL VIEWS OF THE DRAWINGS

FIG. 1 is a block diagram of a system for controlling the graphical user interface elements;

FIG. 2 is an example of the graphical user interface under the control mode;

FIG. 3 is a block diagram of a method for controlling the graphical user interface elements.

### DETAILED DESCRIPTION

Below, the description of possible implementation of the claimed group of inventions is provided. However, the claimed group of inventions is not limited to only these implementations. It will be obvious to experts that other implementation variations may be included within the scope of the claimed group of inventions described in the formula.

In its implementation variations, the claimed technical invention can be executed in a form of computer systems and methods implemented by various computer means, as well as in a form of a computer-readable data carrier containing the instructions executable by the computer processor.

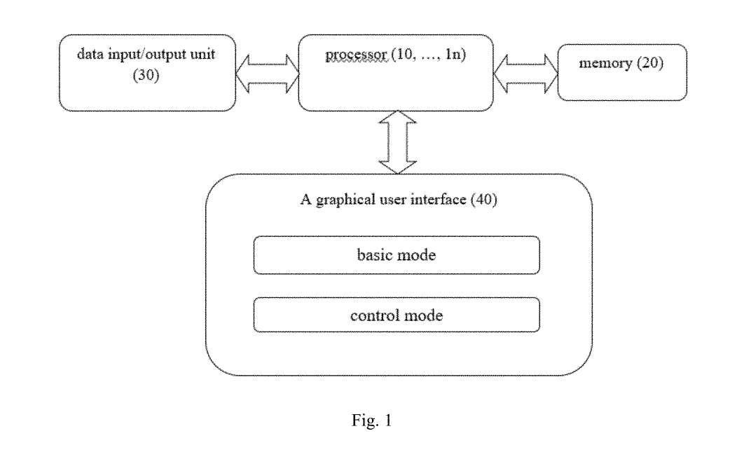

FIG. 1 shows a block diagram of a computer system for controlling the graphical user interface elements. The computer system includes: at least one data processing device (10, . . . , 1n);

memory storage (20); user input/output device (30); and the graphical user interface (40) configured with the possibility of operation in two operating modes—the basic mode and the control mode.

In this context, the computer systems are any computing systems built on the basis of software and hardware, such as: personal computers, smartphones, laptops, tablets, etc.

Processor of computer system in certain implementations can be represented by: a microprocessor, a computer (electronic computer), a PLC (programmable logic controller) or integrated circuit configured for execution of certain user inputs (instructions, programs) related to data processing.

The following items can (but not limited to) act as a memory device: hard disc drives (HDD), a flash memory, a ROM (read-only memory), solid-state discs (SSD), etc.

The user input device can be represented by, but is not limited to, for example, a handle, a mouse, a keyboard, a touchpad, a stylus, a joystick, a trackpad, a sensor keyboard etc.

It should be noted that this computer system may include any other devices known in this field of inventions, for example, such as video surveillance systems, sensors etc.

Next, an example of operation of the above-mentioned computer system for controlling the graphical user interface elements will be described in detail. All steps of the system operation described below are also applicable to the implementation of the claimed method for controlling the graphical user interface elements.

The above-mentioned computer system is a part of the video surveillance system. As it is mentioned above, the graphical user interface (GUI) of the computer system is configured with the possibility of operation in two operating modes. Depending upon the operating mode GUI displays the two-dimensional (2D) and/or three-dimensional (3D) elements. The basic mode of operation is represented by the 2D mode of GUI consisting of several embedded 2D units of control elements. Under this configuration the above-mentioned interface is not at all different from common standard user interfaces applied by the video surveillance systems.

A distinctive feature of this GUI is in providing the user with the opportunity to select at least one unit of control elements for transferring the unit to the control mode.

More than often under the given technological level, the unit of control elements is represented by the video data received from the camera of the closed-circuit television system (CCTV) or by the plan/map of the area. In another possible implementation of this invention, unit of control elements can be represented by several video streams received from the group of cameras of the closed-circuit television system. For example, if the system operator wishes to view video data received from 4 video surveillance cameras simultaneously, then in that case the display screen will be divided in 4 parts and each part would broadcast its own video streaming from various cameras. However, it would be obvious to any expert in this field of inventions that absolutely every unit of elements available in GUI could be controlled. For example, dashboards or even the entire GUI.

Let's suppose that the system operator selected one unit of control elements, which is the video data received from the video surveillance camera. At the same time, this unit is automatically transferred to the control mode, during which it is performed visualization of the graphical representation of at least one 3D shape in the three-dimensional space of GUI. The above-mentioned 3D shape can be represented by any of the shapes consisting of plane faces such as, for example, a cube, a cylinder with plane faces, a dodecahedron, a nut etc. The user interface is configured to use the data representing the three-dimensional models for visualization of various 3D shapes, at that, the system memory is configured for storage of the 3D models of a plurality of various 3D shapes. A specific 3D model is stored in the memory for each shape having different dimensions. In accordance with the basics of the graphical modeling each 3D shape is positioned in the three-dimensional space defined by the axes of coordinates (X,Y,Z).

Getting back to the essence of the claimed invention, the unit of control elements selected by the operator is displayed as the two-dimensional representation on the front face of the visualized 3D shape, for example, on a cube face. At the same time, the context information related to the selected unit of control elements is automatically represented on the remaining all or several faces of the cube (depending on the volume of the information). Context dependence of the information displayed on the auxiliary faces upon the information on the main face increases convenience of using such GUI and decreases the complexity of searching for the required information and/or setting for the user of the system, that finally speeds up the process of operation with the system and results in solving of the set problem within shorter terms.

The context information can be represented by at least one of the following: the settings, dashboards, additional information etc. For example, in the case of representation of the video data received from the video surveillance camera on the front face, the remaining faces might display, for example, the following: 1) settings of the given video camera; 2) emergency situations (a brief description, date and time) and/or dashboards and/or additional information; 3) list of other cameras of the video surveillance system with the possibility of selection of any of the cameras. Therefore, the system operator can obtain the complete information and perform control over each video camera from one of the graphical 3D element, such as a cube.

It should be noted that automatic placing of the context information on the remaining faces of at least one 3D shape is executed in compliance with the degree of relevance (importance) of the context information. Each operator at his/her workplace can initially input the interface settings in a manner that the information that is important exactly for him/her would be placed on the nearest faces, whereas the least required context information would be placed on the far faces of the 3D shape. Nevertheless, the graphical user interface initially possesses the basic settings, which are relevant exactly for the security and protection systems.

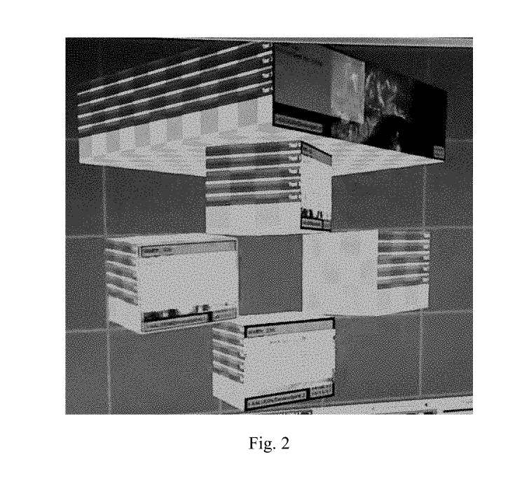

FIG. 2 shows an example of the graphical user interface in the control mode. The feature that distinguishes the claimed GUI from those already known in this field of inventions is also the fact that representation of the data in the 3D form is executed in the control mode only, whereas in the basic mode the operator sees the conventional 2D interface that he/she is used to.

In order to permit the operator easy viewing of all the information placed on all the faces of the 3D shape, the computer system is configured with the possibility of controlling rotation along the axes of coordinates of at least one 3D shape in the three-dimensional space of GUI according to the user's inputs received by the system by means of applying the data input/output device by the user. Control over rotation along the axes of coordinates is executed with the possibility of adjusting the direction and rate of the 3D shape rotation. Moreover, in the case of incomplete rotation of the 3D shape, the computer system can be configured to perform automatic advancement of the 3D shape to its nearest face in the direction set by the operator. It means that the system for controlling the GUI elements can be configured in one of the variations in a way that the 3D cannot merely stop with its edge facing the operator when the latter completed controlling the process of rotation.

More than often, the context information is so abundant that it cannot be represented on the remaining faces of the 3D completely. For the above reason the context information can be placed on the faces in a folded/abridged representation during the time when the operator is viewing the front face in the control mode. However, during rotation of at least one 3D shape it is performed its automatic scaling so that all the context information represented on several or all the faces of the 3D shape could be contained therein during the displaying in the full/unfolded representation.

At the same time, the computer system is configured with the possibility of implementation of two different variants of scaling:

A) during the first variant at automatic scaling of the 3D shape it is equally increased the scale of both the 3D shape and the entire GUI in general;

B) during the second variant at automatic scaling of the 3D shape the scale of the 3D shape is increased in a way that the increased 3D shape superimposes on the remaining elements of the GUI thus obscuring them completely.

The system operator is free to select, which variant is more convenient for him/her in each specific case.

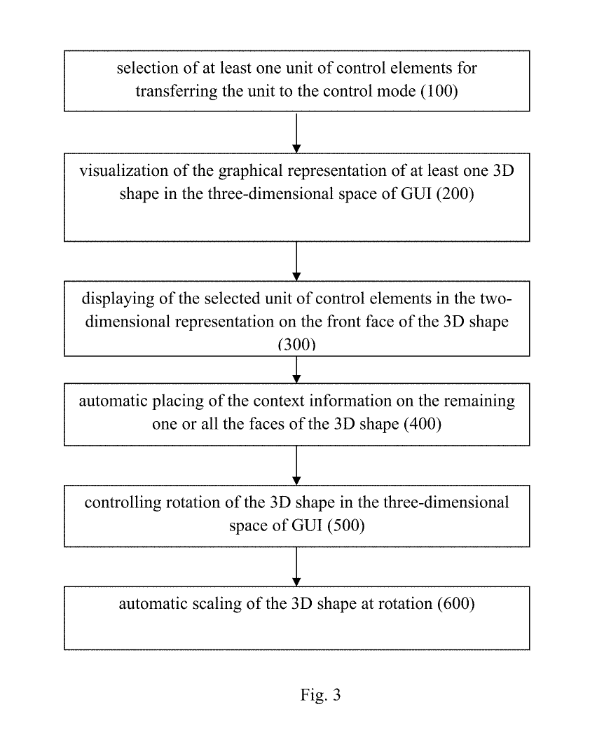

Below it will be described an example of a specific implementation of the method for controlling the graphical user interface elements. FIG. 3 represents a block diagram of one of the variants of implementation of the method for controlling the graphical user interface elements.

The above method is performed by the computer system containing the graphical user interface (GUI) executed with the possibility of representation of the two-dimensional (2D) and three-dimensional (3D) elements depending upon the mode of operation; at the same time, as it is mentioned above, in the basic operation mode the GUI consists of several embedded 2D units of control elements.

The method for controlling the GUI elements includes the stages, at which it is performed: (100) providing the user with the opportunity to select at least one unit of control elements for transferring the unit to the control mode; (200) visualization of the graphical representation of at least one 3D shape in the three-dimensional space of GUI under the control mode, at that, the selected unit of control elements is displayed in the two-dimensional representation on the front face of the 3D shape (300), and the context information (400) related to the selected unit of control elements is automatically represented on the remaining all or several faces of the 3D shape; (500) controlling rotation along the axes of coordinates of at least one 3D shape in the three-dimensional space of GUI according to the user's inputs arriving from the data input/output device, at that, during rotation of at least one 3D shape it is performed its automatic scaling (600) so that all the context information positioned on one or all the faces of the 3D shape could be contained therein during the displaying.

It should be noted that this method can be implemented through the use of a computer system and, therefore, it can be expanded and specified by all the possible implementations that have already been described above for implementing the computer system used for controlling the graphical user interface elements.

In addition, possible implementations of this group of inventions can be implemented with use of software, hardware, software logic, or the combination thereof. In this exemplary implementation, the program logic, software, or the instruction set is stored in one of the conventional computer-readable media, i.e., a computer-readable data carrier.

In the context of this document, a “computer-readable data carrier” can be any medium or means that can comprise, store, transmit, distribute, or transport instructions (commands) that can be used by a computer system such as a personal computer. The computer-readable data carrier may be a non-volatile computer-readable storage medium.

If necessary, at least part of the various operations viewed in the description of this invention can be performed in a manner different from the presented order and/or simultaneously with each other.

Although this technical invention has been described in detail to illustrate the most popular and currently preferred implementations, it is to be understood that the invention is not limited to the disclosed implementations, and moreover, is intended to be modified and combined with other implementations.

For example, it is necessary to understand that the present invention assumes that, to the possible extent, one or more of the features of any possible implementations may be combined with one or more features of any other implementation.

1. The computer system for controlling the graphical user control elements, comprises:
at least one data processing device;
a memory unit configured for storage of video data;
a data input/output device;
the graphical user interface (GUI) executed with the possibility of representing the two-dimensional (2D) and three-dimensional (3D) elements depending upon the mode of operation, at that, in the basic operation mode GUI consists of several embedded 2D units of control elements;
at the same time, the computer system is executed with the possibility of the following:
providing the user with the opportunity to select at least one unit of control elements for transferring the unit to the control mode;
visualization of the graphical representation of at least one 3D shape in the three-dimensional space of GUI under the control mode,
at that, the selected unit of control elements is displayed in the two-dimensional representation on the front face of the 3D shape, and the context information related to the selected unit of control elements is automatically represented on all or several remaining faces of the 3D shape;
controlling the rotation along the axes of coordinates of at least one 3D shape in the three-dimensional space of GUI according to the user's inputs arriving from the data input/output device,
at that, during the rotation of at least one 3D shape, its automatic scaling is performed so that all the context information positioned on one or all the faces of the 3D shape could be contained therein during the displaying.

2. The computer system of claim 1, wherein the unit of control elements is represented by the video data received from the camera of the closed-circuit television system (CCTV).

3. The computer system of claim 1, wherein the unit of control elements is represented by several video streams received from the group of cameras of the closed-circuit television system.

4. The computer system of claim 1, wherein the unit of control elements is represented by the map or plan of the area.

5. The computer system of claim 1, wherein the unit of control elements is represented by the dashboard.

6. The computer system of claim 1, wherein the unit of control elements is represented by the entire GUI.

7. The computer system of claim 1, wherein the context information is represented by at least one of the following: the settings, dashboards or additional information.

8. The computer system of claim 7, wherein the automatic placing of the context information on the remaining faces of at least one 3D shape is executed in compliance with the degree of relevance of the context information.

9. The computer system of claim 1, wherein the control over rotation along the axes of coordinates is executed with the possibility of adjusting the direction and rate of the 3D shape rotation.

10. The computer system of claim 9, which is additionally configured for automatic advancing of the 3D shape to its nearest face in the given direction at incomplete rotation of the 3D shape.

11. The computer system of claim 1, wherein at automatic scaling of the 3D shape, the scale of both the 3D shape and the entire GUI in general is equally increased.

12. The computer system of claim 1, wherein at automatic scaling of the 3D shape the scale of the 3D shape is increased in a way that the increased 3D shape superimposes on the remaining elements of the GUI thus obscuring them completely.

13. The computer system of claim 1, wherein the user input device can be represented by a mouse, a keyboard, a joystick, a touchpad and a sensor keyboard.

14. The computer system of claim 1, wherein the visualized 3D shape can be represented by any shape consisting of plane faces.

15. The computer system of claim 14, wherein the visualized 3D shape can be represented by at least one of the following shapes—a cube, a cylinder with plane faces and a dodecahedron.

16. The method for controlling the graphical user control elements, which is performed by the computer system containing the graphical user interface (GUI) executed with the possibility of representing the two-dimensional (2D) and three-dimensional (3D) elements depending upon the mode of operation, at that, in the basic operation mode GUI consists of several embedded 2D units of control elements, at the same time, the method includes the following:
the stage of providing the user with the opportunity to select at least one unit of control elements for transferring the unit to the control mode;
the stage of visualization of the graphical representation of at least one 3D shape in the three-dimensional space of GUI under the control mode,
at that, the selected unit of control elements is displayed in the two-dimensional representation on the front face of the 3D shape, and the context information related to the selected unit of control elements is automatically represented on all or several remaining faces of the 3D shape;
the stage of controlling rotation along the axes of coordinates of at least one 3D shape in the three-dimensional space of GUI according to the user's inputs arriving from the data input/output device,
at that, during rotation of at least one 3D shape, its automatic scaling is performed so that all the context information positioned on one or all the faces of the 3D shape could be contained therein during the displaying.

17. The method of claim 16, wherein the unit of control elements is represented by the video data received from the camera of the closed-circuit television system (CCTV).

18. The method of claim 16, wherein the unit of control elements is represented by several video streams received from the group of cameras of the closed-circuit television system.

19. The method of claim 16, wherein the unit of control elements is represented by the map or plan of the area.

20. The method of claim 16, wherein the unit of control elements is represented by the dashboard.

21. The method of claim 16, the unit of control elements is represented by the entire GUI.

22. The method of claim 16, wherein the context information is represented by at least one of the following: the settings, dashboards or additional information.

23. The method of claim 22, wherein automatic placing of the context information on the remaining faces of at least one 3D shape is executed in compliance with the degree of relevance of the context information.

24. The method of claim 16, wherein control over rotation along the axes of coordinates is executed with the possibility of adjusting the direction and rate of the 3D shape rotation.

25. The method of claim 24, which is additionally configured for automatic advancing of the 3D shape to its nearest face in the given direction at incomplete rotation of the 3D shape.

26. The method of claim 16, wherein at automatic scaling of the 3D shape, the scale of both the 3D shape and the entire GUI in general is equally increased.

27. The method of claim 16, wherein at automatic scaling of the 3D shape the scale of the 3D shape is increased in a way that the increased 3D shape superimposes on the remaining elements of the GUI thus obscuring them completely.

28. The method of claim 16, wherein the user input device can be represented by a mouse, a keyboard, a joystick, a touchpad and a sensor keyboard.

29. The method of claim 16, wherein the visualized 3D shape can be represented by any shape consisting of plane faces.

30. The method of claim 29, wherein the visualized 3D shape can be represented by at least one of the following shapes—a cube, a cylinder with plane faces and a dodecahedron.

31. A computer-readable data carrier comprising instructions executable by the computer processor for implementing methods for controlling the graphical user interface elements of any of claims 16.
